(19) United States
(12) Patent Application Publication
(10) Pub. No.: US 2005/0230865 A1
(43) Pub. Date: Oct. 20, 2005

(54) Method and apparatus for manufacturing imitation pearl beads

(76) Inventors: Young Nam Rhee, Seoul (KR); Sang Min Rhee, San Jose, CA (US)

Correspondence Address: PARK & SUTTON LLP, 3255 WILSHIRE BLVD, SUITE 1110, LOS ANGELES, CA, 90010, US

(21) Appl. No.: 10/825,164

(22) Filed: Apr. 16, 2004

(51) Int. Cl. B29C 43/36

(52) U.S. Cl. 264/102; 425/408; 425/468; 264/319; 264/109

(57) ABSTRACT

The present invention relates to a method and apparatus for manufacturing imitation pearl beads with/without holes for use in ornaments and accessories. To manufacture the imitation pearl beads, an upper mold having a semicircular recess is fixed at the upper portion of the body of the apparatus, and a lower mold also having a semicircular recess is installed below the upper mold in such a manner that the lower mold descends or ascend. As the lower mold and the upper mold meet, urea resin powder in the recesses is melted and beads are molded through primary and secondary molding processes.

### BACKGROUND OF THE INVENTION

1. Field of the Invention

The present invention relates to a method and apparatus for manufacturing imitation pearl beads for use in ornaments and accessories (necklace, ring, bracelet and so on).

2. Description of the Related Art

Imitation pearl beads are made of resin and thus, can be mass-produced and are relatively cheap. By coating different shapes of beads with pearl liquid, imitation pearls have natural pearl colors and are broadly used in every kind of ornaments and accessories.

Although there are many kinds of resins that can be used for imitation pearls, thermoplastic urea resins are used most.

Urea resins are known to be plastic or easily molded and have a very weak adhesive force. Thus, they do not easily adhere to a mold during a congelation process. These physical properties of urea resins verify that why urea resins are used most often as materials for imitation pearl beads.

According to a related art method and apparatus for manufacturing imitation pearl beads, circular beads for example (oval, semicircle, triangle, or square beads are also possible) are manufactured by employing two molds, namely the upper/lower molds. Each mold has a semicircular recess and is preheated to an appropriate temperature. In other words, urea resin in powder form is poured into the semicircular recess formed on the lower mold, and the upper mold descends to the lower mold until it is tightly closed to the lower mold. The urea resin in the recess is melted by heated molds, and as a result, a circular bead is molded. In case of manufacturing a bead with a hole, a pin for perforating the bead is formed at the center of each semicircular recess of the upper and lower molds. If there is no need to make a hole in the bead, the upper and lower molds with semicircular recesses are all that are required.

However, the above-described bead forming apparatus posed many problems.

First of all, because the upper mold descends to the lower mold at a certain speed, air pressure is generated to the descending upper mold and the air pressure affects the urea resin powder in the semicircular recess of the lower mold. As a result, the urea resin powder blows or is scattered. Although the upper mold could be descended more slowly to obviate the problem, it gives rise to another problem, such as deterioration of productivity.

Second, because the molding is done once, an air space may be created on the surface of the bead, or the surface can be cracked. Whenever this happens, merchantability of the bead is lowered.

Third, this is probably the most serious problem of all. When the urea resin is melted at a high temperature, highly toxic gas is generated. However, when this toxic gas is not properly exhausted, an air space is created and the toxic gas remains inside of the bead.

When the toxic gas—containing beads are used for imitation pearls for purpose of ornament, the toxic gas will escape little by little for many hours and eventually cause a rash and itch.

For the seriousness of the above problem, many developed countries set strict rules to limit the permissible level of toxic gases contained in the resin beads for imitation pearls.

Lastly, it is not easy to form a pin in the semicircular recess of each mold. Even if a bead with a hole is successfully molded, it is very difficult to release the bead from the molds.

### SUMMARY OF THE INVENTION

It is, therefore, an object of the present invention to provide a method and apparatus for manufacturing imitation pearl beads with/without a hole, in which a lower mold translates vertically at a constant speed by an elevating means (i.e. a piston) that is driven by air pressure or a hydraulic cylinder. Also, the bead is molded twice so that toxic gas generated from the bead through a primary molding can be sufficiently removed and is not remained in the bead when a secondary molding is completed. As a result, the content of toxic gas in the bead is very low, air space on the surface of the bead is considerably reduced, and high quality beads are obtained.

Another object of the invention is to provide a method for neatly perforating a bead and thus, for improving productivity and quality of beads, in which a pinhole is directly formed in a semicircular recess of a lower mold, and a pin is inserted into a pinhole, where the pin is stuck in a pin block that is installed below the lower mold and translates vertically.

To achieve the above object, there is provided a method for manufacturing imitation pearl beads, wherein the method includes five processes as follows.

In the first process, an upper mold having a semicircular recess at the bottom surface and a lower mold having a semicircular recess at the top surface are installed on the opposite sides, being spaced out by a designated distance. A pinhole is formed in the semicircular recess of the lower mold, and a pin to be inserted into the pinhole is stuck in a pin block. The pin block moves upward and downward by means of a piston of an air cylinder. When an appropriate amount of urea resin powder (C) is poured on the pin block, as illustrated in FIG. 2, the piston of the air cylinder pushes up the lower mold by a first ascending space (h1).

When the lower mold ascends, the pin of the pin block is inserted into the pinhole formed in the semicircular recess.

In the second process, the ascending speed of the lower mold within the first ascending space (h1) is considerably lowered in the vicinity of the upper mold, but gradually increased within a second ascending space (h2). The lower mold keeps ascending until it hits the upper mold. At this time, the pin in the pinhole in the semicircular recess of the lower mold is pushed up by the pin block, and enters the semicircular recess of the upper mold. Meanwhile, the urea resin powder on the lower mold is melted by heaters installed at the upper and lower molds. Hence, beads (b) are molded primarily while the pin is being inserted into the semicircular recessed of the upper and lower molds.

In the third process, after the primary molding process is over, the piston descends a little, creating a gas exhaust space (h3) between the upper mold and the lower mold. Thus, toxic gas generated from the urea resin during the primary bead molding process is exhausted to outside through the gas exhaust space (h3).

In the fourth process, the piston ascends again by the gas exhaust space (h3), and the upper mold and the lower mold, and the secondary molding process begins.

In the fifth process, when the secondary molding process is completed, the piston descends, as shown in FIG. 7, and the lower mold also descends until it hits the base of the body of the apparatus. When the lower mold stops descending, the pin stuck in the pin block, it having been descended along the piston, comes out of the twice-molded bead.

Preferably, the ascending speed of the lower mold during the primary molding process for beads w/wo holes ranges 10-30 cm/sec. This is because when the speed is greater than 10-30 cm/sec, productivity is deteriorated, and when the speed is less than 10-30 cm/sec, urea resin powder on the lower mold may be scattered.

Preferably, the ascending speed of the lower mold within the second ascending space 9h2) is below 10 cm/sec. When the speed is greater than 10 cm/sec, a pressure is generated between the upper mold and the lower mold, and because of the pressure, urea resin powder is either scattered or not spread evenly.

### BRIEF DESCRIPTION OF THE DRAWINGS

The above objects, features and advantages of the present invention will become more apparent from the following detailed description when taken in conjunction with the accompanying drawings, in which:

FIG. 1 is a perspective view of a partially cut away view of an apparatus for manufacturing imitation pearl beads according to the present invention;

FIG. 2 is a cross-sectional view of an apparatus for manufacturing imitation pearl beads according to the present invention, in which a lower mold for forming a bead is descended;

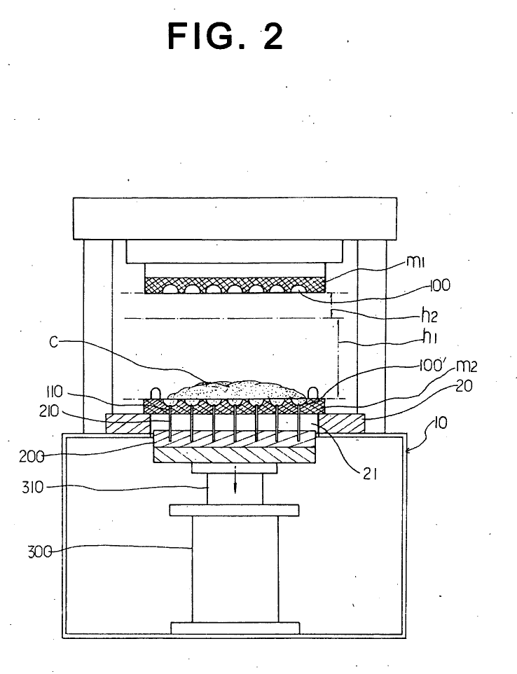

FIG. 3 is a cross-sectional view of an apparatus for manufacturing imitation pearl beads according to the present invention, in which a lower mold for forming a bead ascends;

FIG. 4 is a cross-sectional view of an apparatus for manufacturing imitation pearl beads according to the present invention, in which a bead is formed through a primary molding process;

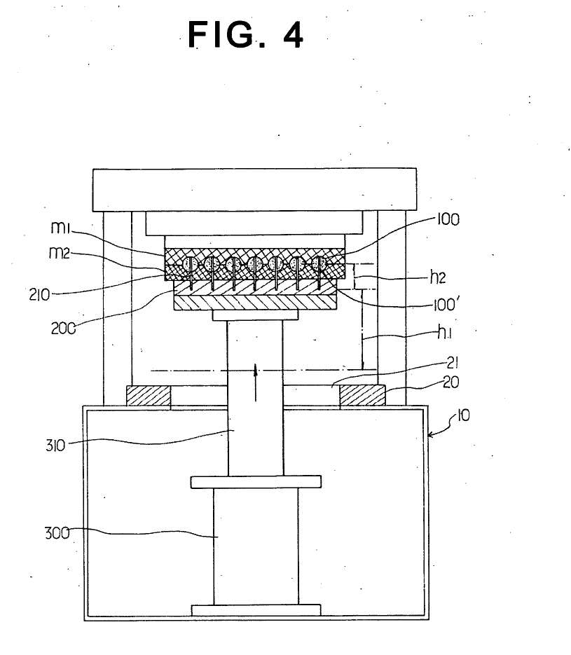

FIG. 5 is a cross-sectional view of an apparatus for manufacturing imitation pearl beads according to the present invention, in which a lower mold descends by a designated space in order to exhaust toxic gas generated from a primary molding process;

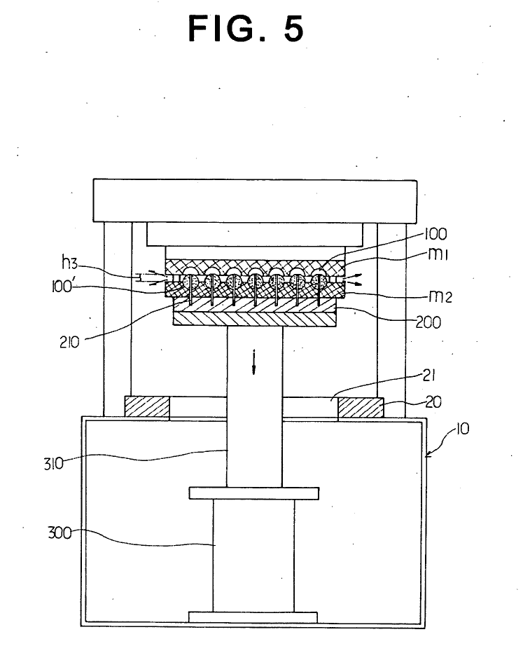

FIG. 6 is a cross-sectional view of an apparatus for manufacturing imitation pearl beads according to the present invention, in which a secondary molding process is performed on a bead after exhausting toxic gases generated from primary molding process; and

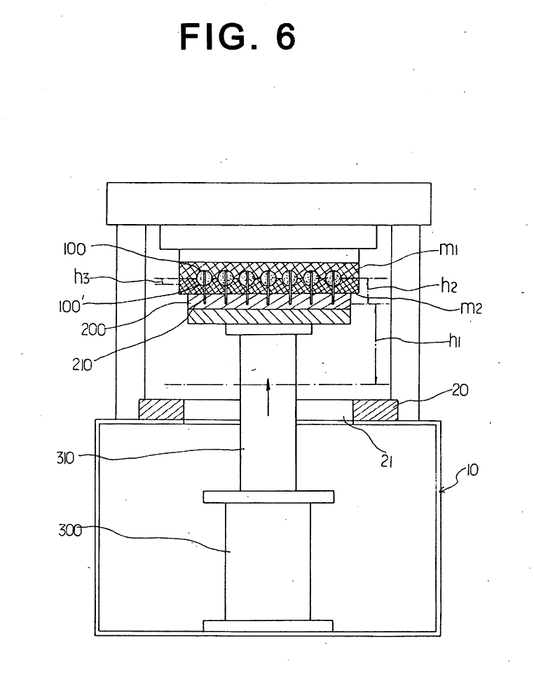

FIG. 7 is a cross-sectional view of an apparatus for manufacturing imitation pearl beads according to the present invention, in which a lower mold is descended, to collect completely molded beads.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

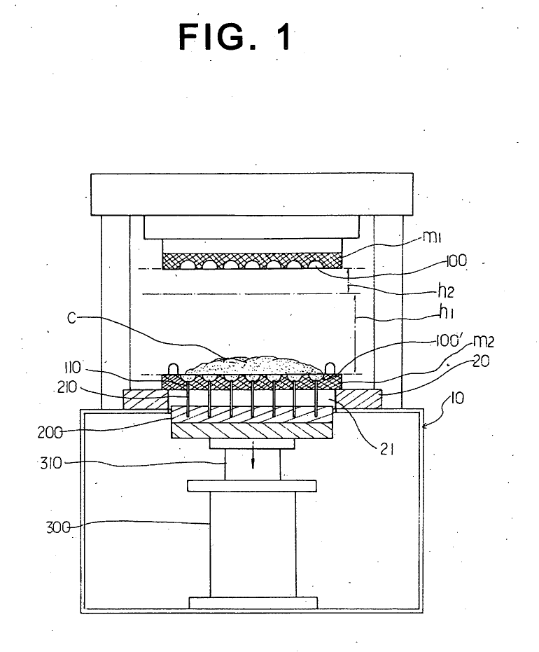

As shown in FIG. 1, an apparatus for manufacturing imitation pearl beads includes an upper mold (m1) fixed at the upper portion of a body 10 of the apparatus; a base 20 fixed at the central portion of the body 10 and having a pin block entrance 21; a lower mold (m2) disposed on the base 20, and being opposed from the upper mold (m1) by a designated space to be able to move upward or downward; semicircular molding recesses 100 and 100′ formed on the upper and lower molds (m1) (m2); a pin block 200 for holding pins 210 that pass through pin holes 110 formed in the recess 100′ of the lower mold (m2); and a cylinder 300 having a piston 310 for replacing the pin block 200.

The cylinder 300 is driven by air pressure or hydraulic pressure. Also, the speed of the piston 310, a related computer program, or a hand valve can drive the cylinder 300.

According to the invention, the lower mold translates vertically or ascends/descends so that the material for use in bead molding, e.g., resin powder like urea resin powder, which is on the flat lower mold is not easily scattered, compared to the related art apparatus where the upper mold is the one ascending/descending from/to the lower mold.

The following provides an exemplary embodiment of the present invention.

### EMBODIMENT

An appropriate amount of urea resin powder is poured on the flat lower mold in descending mode.

The amount of urea resin powder is determined in dependence of the area of the semicircular recess formed on the upper and lower molds, respectively.

A heater is installed at the upper and lower molds. Particularly, the heater for the lower mold can be installed at the pin block 200.

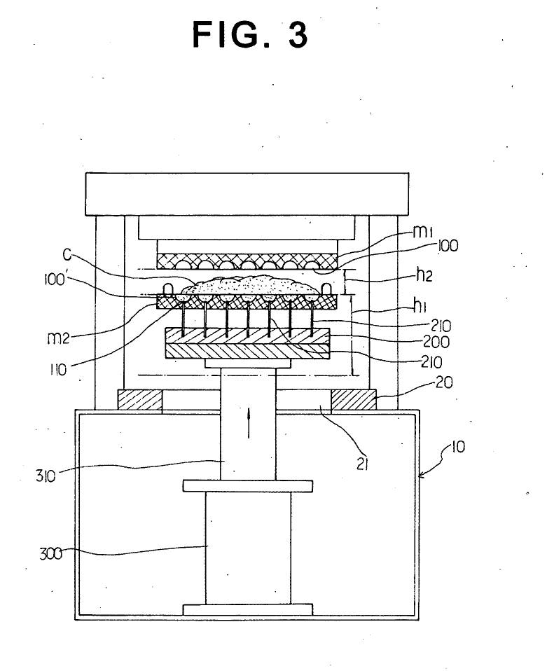

The pin fixed at the pin block is tightly inserted into the pinhole formed in the lower mold. Therefore, when the lower mold ascends as shown in FIG. 3, a constant space is maintained between the lower mold and the pin block 200.

The lower mold first ascends within a first ascending space (h1) at a desired speed of 10-30 cm/sec. In fact, the urea resin powder is not scattered when the lower mold ascends at a speed of 30-50 cm/sec.

When the lower mold ascends to a second ascending space (h2), its ascending speed falls below 10 cm/sec. However, it is also acceptable to have the speed in the range of 10-15 cm/sec.

Although the lower mold stops ascending as it touches the upper mold, the piston 310 keeps ascending, and the pin in the pinhole is inserted into the semicircular recesses of the upper and lower molds and perforates the bead during the primary molding process.

The time required for the primary molding of the bead varies according to the size of the bead or the temperature difference between the molds. In case of molding a 1 cm bead in diameter, a preferable molding time is 3-5 sec.

When the primary molding is over, as a part of the process of toxic gas exhausting, the lower mold in contact with the upper mold starts descending to a gas exhaust space (h3) as the piston 310 goes down. A desired gas exhaust space is 5-10 mm. If the gas exhaust space (h3) is small, gas exhaust time is extended, but if the gas exhaust space (h3) is large, gas exhaust time is shortened.

Once the gas exhausting process is finished, the lower mold again ascends to perform a secondary molding process. The time required for the secondary molding is equal to or longer than the time taken for the primary molding.

When the secondary molding is completed, the pin block 200 and the lower mold descend following the piston 310. The lower mold stops descending when it touches the base 20, and only the pin block 200 keeps descending by passing through a pin block passing hole formed on the base 20.

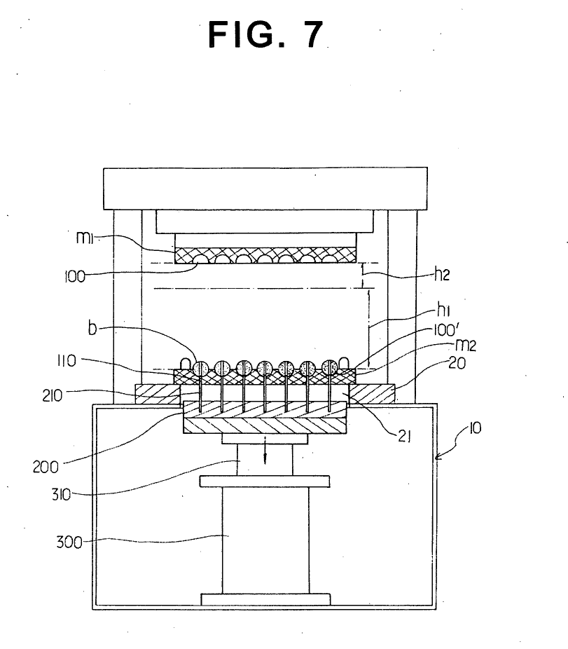

At this time, the pin 210, as shown in FIG. 7, goes through the semicircular recess of the lower mold and comes out of the bottom surface of the recess.

Referring again to FIG. 7, when the bead molding process is completed, beads are collected from the lower mold. Then, the burr on the bead surface is removed, and the beads undergo a polishing process. By coating the bead surface with pearl liquid, imitation pearls are manufactured.

The same method is applied to mold beads without a hole, except that there is no need for the pin 210 to ascend to perforate the bead during the primary molding process. Further, there is no pin to come out of the bead after the secondary molding process. As for the apparatus, there is neither the pinhole 110 in the bead molding recess 100′ of the lower mold (m2) nor the pin 210 and pin block 200 on the bottom surface of the lower mold (m2). Thus, the piston 310 directly pushes up the lower mold (m2) to produce beads without a hole.

Operational effects of the present invention will be now explained below.

Since the upper mold (m1) is fixed and only the lower mold (m2) moves vertically by means of the air cylinder 300, it is easy to adjust the ascending/descending speed of the lower mold (m2), and the urea resin powder on the lower mold (m2) is less scattered or lost. Moreover, more beads are effectively molded by differing the first ascending speed from the second ascending speed. Since the beads are molded twice (the primary and secondary molding processes), the number of air holes is reduced and illuminance on the bead surface is improved. Especially, because toxic gas is automatically exhausted after the primary molding process, the beads are harmless and nontoxic.

When the molding process is not performed, the pin 210 is usually out of the semicircular recess 100′ formed in the lower mold (m2). However, when the primary molding process is undertaken, the pin 210 enters the semicircular recesses 100 and 100′ of the upper and lower molds simultaneously, and as a result, a pinhole is formed in each bead. When the secondary molding process is over and the lower mold (m2) descends, the pin 210 inserted in the bead automatically comes out of the bead. Therefore, a pinhole is formed neatly in the bead.

In conclusion, the method and apparatus of the present invention makes it possible to mass-produce high quality beads with less manpower since the bead molding processes are done automatically by the apparatus. Moreover, by manufacturing imitation pearl beads through the primary and secondary molding processes, quality of the beads is considerably improved. The present invention is also effective for manufacturing nontoxic beads by automatically removing toxic gas generated from raw materials of the beads.

While the invention has been described in conjunction with various embodiments, they are illustrative only. Accordingly, many alternative, modifications and variations will be apparent to persons skilled in the art in light of the foregoing detailed description. The foregoing description is intended to embrace all such alternatives and variations falling with the spirit and broad scope of the appended claims.

1. A method for manufacturing imitation pearl beads, the method comprising the steps of:
pouring a designated amount of urea resin power on a lower mold, and ascending the lower mold by a first ascending space (h1) at a high speed, wherein an upper mold is fixed and the lower mold translates vertically by means of a piston of an air cylinder;
when the lower mold is in contact with the upper mold as a pin block slowly ascends from a second ascending space (h2), performing a primary molding process, inserting a pin stuck in the pin block into a semicircular recess formed in each of the upper and lower molds, and perforating a hole in the bead;
descending the lower mold by a gas exhaust space (h3), and exhausting toxic gas generated during the primary molding process;
ascending the lower mold again, and performing a secondary molding process; and
descending the lower mold until the lower mold touches a base, and descending the pin block until the pin of the pin block comes out of the secondly molded bead.

2. The method according to claim 1, wherein an ascending speed of the lower mold within the first ascending space (h1) ranges 10-30 cm/sec.

3. The method according to claim 1, wherein an ascending speed of the lower mold within the second ascending space (h2) ranges 5-10 cm/sec.

4. The method according to claim 1, wherein the ascending speed of the lower mold is variable.

5. The method according to claim 1, wherein the lower mold is descended by the gas exhaust space (h3), in order to remove toxic gas generated from the primary bead molding process.

6. The method according to claim 1, wherein the gas exhaust space (h3) ranges 5-30 mm.

7. An apparatus for manufacturing imitation pearl beads, the apparatus comprising:
an upper mold fixed at the upper portion of a body of the apparatus;
a base fixed at the central portion of the body and having a pin block entrance;
a lower mold disposed on the base, and being opposed from the upper mold by a designated space to move upward or downward;
semicircular molding recesses formed on the upper and lower molds, respectively;
a pin block for holding pins that pass through pin holes formed in the recess of the lower mold; and
a cylinder having a piston for replacing the pin block.

8. The apparatus according to claim 7, wherein the upper mold is fixed and the lower mold translates vertically.

9. The apparatus according to claim 7, wherein to perforate the bead, the pin stuck in the pin block is inserted into the pinhole that is perforated on the semicircular bead molding recess of the lower mold.

10. The apparatus according to claim 7, wherein an ascending speed of the piston is variable.

11. The apparatus according to claim 7, wherein after a primary molding process, the lower mold being in contact with the upper mold descends by a designated space and toxic gas is exhausted.
